(19) United States
(12) Patent Application Publication
(10) Pub. No.: US 2025/0339945 A1
(43) Pub. Date: Nov. 6, 2025

(54) Tent stake and Trowel Driving Device

(71) Applicant: Jeremy Evan Kocsis, Varysburg, NY (US)

(72) Inventor: Jeremy Evan Kocsis, Varysburg, NY (US)

(21) Appl. No.: 18/642,462

(22) Filed: Apr. 22, 2024

(51) Int. Cl. B25D 1/10; B33Y 80/00; E04H 15/62

(52) U.S. Cl. CPC B25D 1/10; E04H 15/62; B33Y 80/00

(57) ABSTRACT

The disclosed invention pertains to a Tent Stake & Trowel Driving Device, designed to address safety concerns and operational efficiency in outdoor activities. Crafted with precision using advanced manufacturing techniques, such as 3D-printing technology, the device features a compact and lightweight handle that seamlessly fits over tent stakes and trowels. This ergonomic handle not only provides protection against potential injuries from sharp edges but also enhances operational efficiency by offering increased surface area for improved leverage during the process of embedding tent stakes and trowels into the soil. The design further allows for easy attachment of paracord or similar cordage, facilitating convenient carrying and storage. This innovation represents a notable advancement in the outdoor industry, addressing longstanding challenges associated with conventional stake and trowel manipulation and setting new standards for safety and functionality in outdoor equipment design.

### CROSS-REFERENCE TO RELATED APPLICATIONS

Provisional Patent

Application Number: 63/501,385

Filing or 371(c) Date: May 10, 2023

### BACKGROUND OF INVENTION

In my capacity as a mechanical engineer and professional within the outdoor industry, my perpetual pursuit of innovative problem-solving has led me to address a common predicament faced by outdoor enthusiasts. Specifically, the challenge revolves around safeguarding hands from the sharp edges inherent in tent stakes and digging trowels during the process of embedding them into the soil.

To tackle this issue comprehensively, I have conceptualized and developed a solution in the form of a compact and lightweight handle. This ergonomic handle is meticulously designed to seamlessly fit over tent stakes and trowels, serving the dual purpose of shielding the user from potential injuries while concurrently enhancing operational efficiency. The primary objective is to provide an extended surface area for improved leverage and ease of pushing, addressing the ergonomic shortcomings associated with conventional stake and trowel manipulation.

It is noteworthy that several prominent companies within the industry have attempted and failed to mitigate either one of these challenges, but none have successfully addressed both simultaneously. The innovation presented in the form of the Tent Stake & Trowel Driving Device stands out due to its simplicity and elegance in resolving these longstanding issues. Through a meticulous blend of mechanical engineering principles and a deep understanding of outdoor enthusiasts' needs, the Tent Stake & Trowel Driving Device emerges as a groundbreaking solution that surpasses previous attempts, elevating the standards of safety and functionality in outdoor equipment.

### SUMMARY OF INVENTION

The central challenge at hand pertains to the imperative need to safeguard the hands of outdoor enthusiasts from the inherent sharp edges found in tent stakes and digging trowels. The act of embedding these tools into the soil, a routine task in outdoor activities, poses a risk of injury due to these sharp edges.

In response to this multifaceted challenge, a meticulously conceptualized and developed solution has emerged—a compact and lightweight handle. This handle, crafted with precision, represents a sophisticated ergonomic design explicitly tailored to seamlessly integrate with both tent stakes and trowels. Its dual functionality serves to shield the user from potential injuries while concurrently elevating operational efficiency.

The primary objective of this innovative handle is to provide an extended surface area, thereby enhancing leverage and facilitating ease of pushing. This design consideration is instrumental in mitigating the ergonomic shortcomings commonly associated with conventional stake and trowel manipulation, thus optimizing the overall user experience.

Worth highlighting is the fact that despite numerous attempts by prominent companies within the industry to address either the tent stake or trowel challenge individually, they have met with limited success and have not managed to concurrently resolve both issues. The sophistication and effectiveness of the proposed handle stand out, marking a notable departure from previous endeavors. Its comprehensive approach to safety and functionality positions it as a groundbreaking solution, setting new standards within the realm of outdoor equipment design and innovation.

### DESCRIPTION OF DRAWINGS

FIG. 1 presents a comprehensive mechanical engineering drawing of the Tent Stake & Trowel Driving Device, offering meticulous detailing of all dimensions and providing multiple perspectives for a thorough understanding. The drawing includes top, front, right, left, and rear sketches, accompanied by an isometric view of the solid body, ensuring a comprehensive visualization of the device's geometric intricacies.

The top sketch delineates the device's uppermost aspect, showcasing intricate details such as the attachment point for paracord, the area in which a clear display of the device's name will be located, and any additional features on the upper surface. The front sketch provides a frontal view, offering insights into the circular hole for tent stakes and the crescent-shaped slot for trowels, emphasizing the functional aspects crucial for stake and trowel integration.

Moving to the right and left sketches, a detailed examination of lateral dimensions and features is facilitated. These views allow for a thorough assessment of symmetry, proportions, and any specific design elements that may be present on either side. Meanwhile, the rear sketch provides insights into features situated at the back of the device, completing the holistic examination of its external geometry.

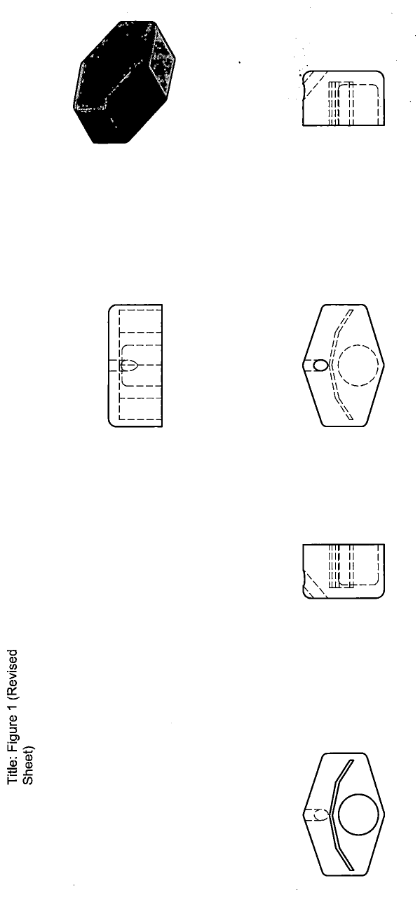

Finally, the isometric views offer a three-dimensional representation, enabling a more immersive understanding of the Tent Stake & Trowel Driving Device. By combining all these perspectives in a single mechanical engineering drawing, FIG. 1 serves as an invaluable reference for engineers and designers, providing a detailed blueprint of the device's form and function.

### DETAILED DESCRIPTION OF INVENTION:

At the base of the device, a carefully designed small circular orifice serves as a receptacle for tent stakes, providing a secure and stable fit. Simultaneously, a crescent-shaped slot is strategically incorporated to accommodate trowels with precision, ensuring a seamless integration of functionality for outdoor tasks.

The top segment of the device features a prominent display of its nomenclature, serving both as an identifier and a testament to its purpose. To augment its practicality, a strategically positioned small orifice is included for the attachment of paracord or similar cordage. This design consideration facilitates ease of carrying and storage, addressing the practical needs of users in diverse outdoor scenarios.

In summary, the meticulous engineering and thoughtful incorporation of features in this tool exemplify a commitment to technical precision, durability, and user-centric design, making it an indispensable asset for outdoor enthusiasts seeking advanced and reliable equipment.

1: A compact and lightweight Tent Stake & Trowel Driving Device, designed for outdoor applications and addressing the challenges associated with protecting hands from sharp edges of tent stakes and digging trowels during soil embedding, said device comprising:
a. A handle crafted from durable materials suitable for outdoor use,
b. An ergonomic design featuring a compact structure for easy handling,
c. The handle seamlessly fitting over tent stakes and trowels,
d. The handle providing protection against potential injuries caused by sharp edges,
e. The handle enhancing operational efficiency by offering increased surface area for improved leverage during pushing,
f. The ergonomic design mitigating the ergonomic shortcomings commonly associated with conventional stake and trowel manipulation.

2: Tent Stake & Trowel Driving Device of claim 1, wherein the handle is fabricated using advanced manufacturing techniques, including but not limited to 3D-printing and additive manufacturing technologies, to ensure precision, durability, and lightweight properties.

3: Tent Stake & Trowel Driving Device of claim 1, wherein the ergonomic design of the handle is configured to provide a comfortable and efficient grip for users, optimizing the overall user experience during stake and trowel manipulation.
